(19) United States
(12) Patent Application Publication
(10) Pub. No.: US 2002/0168499 A1
(43) Pub. Date: Nov. 14, 2002

(54) Laminated plastic and metal component and process for producing same

(76) Inventors: Hubert Goldbach, Ratingen (DE); Dieter Schauf, Leichlingen (DE)

Correspondence Address: BAYER CORPORATION, PATENT DEPARTMENT, 100 BAYER ROAD, PITTSBURGH, PA, 15205, US

(21) Appl. No.: 10/140,615

(22) Filed: May 7, 2002

Related U.S. Application Data
(63) Continuation-in-part of application No. 09/879,522, filed on Jun. 12, 2001, now abandoned.

(30) Foreign Application Priority Data
Jun. 15, 2000 (DE) 10029411.1

(51) Int. Cl. B32B 3/10

(52) U.S. Cl. 428/139; 264/261

(57) ABSTRACT

A laminated plastic and metal component is described, consisting of at least two metallic molded parts and which are connected to one another by injected thermoplastic molding composition, characterized in that in the area of the connection point of the molded parts, the molded parts form with the plastic a form closure, and in that the molded parts have no direct contact with one another, and in that the plastic forms an electrically insulating layer between the molded parts.

### CROSS-REFERENCE TO RELATED APPLICATION

This application is a continuation-in-part of application Ser. No. 09/879,522, filed on Jun. 12, 2001.

The invention relates to a laminated plastic and metal component consisting of at least two metallic molded parts which are connected to one another by injected thermoplastic molding composition (herein plastic), characterized in that in the area of the connection point of the moulded parts the molded parts form with the plastic a form closure, that the molded parts have no direct contact with one another, and that the plastic forms an electrically insulating layer between the molded parts.

The form-closed laminate of the components of various materials is obtained by forming of a thermoplastic material.

Laminated components or semi-finished products used in practice consist of e.g. flat-shaped laminates in which e.g. two metal plates are combined to form a sandwich structure with the aid of an intermediate plastic or plastic foam (cf. EP 489 320 Al). In addition to this there are processes for producing laminated plates with outer-lying sheets and inner-lying ribbed structure (see EP 775 573 A2). Furthermore there is a process for connecting sheets by a combination of pressing and injection molding in a die (EP 72-1 831 A1). In addition, laminated plastic/metal components are also known in which metal plates are supported by ribbed structures (EP 370 342 A3).

In the present process, laminated components are produced which consist of in particular high strength and high rigidity metal components, such as for example of steel, which are jointed by means of a thermoplastic molding composition, held in position, electrically isolated from one another and preferably additionally supported by supporting structures in the form of ribs or massive walls.

High strength combinations of supports, sections, plates, etc. which may be subjected to high stresses are frequently found in vehicle or machine construction. Steel or aluminium supports are mainly used there, which are welded or bonded to one another in the joint areas. All mass-produced laminated metal components are either welded, bolted, riveted or bonded. Welding in particular often causes difficulties due to the incompatibility of the materials. A bonding of metal components is expensive on account of the pre-treatment of the metal parts. A very economical connection between metal parts and plastic is already employed for light-weight structures in the mass production for passenger car components. The basic principle is described in detail in the German laid-open application DE 3 839 855 A1. Fault is also frequently found with the vaporization method or acoustic radiation in the case of housings, which may be improved by the connection of the metal parts to a plastic (e.g. in the case of oil sumps or valve caps). In addition, the connection of various metals, in particular with an application in the wet range (e.g. in the engine bay or chassis area of vehicles), leads to electrolytic corrosion unless the latter are adequately protected against corrosion. Said defect may also occur due to abrasion effects in the connection area.

The laminated components produced with conventional jointing methods or by welding therefore have the disadvantage that the direct contact of metal to metal may lead to corrosion and hence to the failure of such a laminated component.

The invention is therefore based on the object of creating a laminated component of the kind mentioned in the preamble which is both to make possible high strength and high rigidity connections of metallic supports and sheets and to permit an economic jointing of semi-finished products and component parts to components. For example, housings or structural parts of various metals are to be connected, e.g. high strength steel plate connected to aluminium plates or magnesium die-cast parts, wherein electrolytic corrosion is to be prevented and a form-closed connection is made possible with or without openings in the metal parts together with an adequate force transmission. In addition, a thermal and acoustic decoupling of the metal parts to be connected is desirable. At the same time an electrical isolation of the connected metal parts is to be made possible by the intermediate layer of thermoplastic material and possible corrosion prevented.

This object is achieved according to the invention by use being made for connecting the metallic molded parts of thermoplastic molding composition, which connects the metallic molded parts to one another in a form closure and at the same time forms an electrical insulating layer.

The invention provides a laminated plastic and metal component consisting of at least two metallic molded parts which are connected to one another by injected thermoplastic molding composition, characterized in that in the area of the connection point of the molded parts. The molded parts form with the plastic a form closure that the molded parts have no direct contact with one another, and that the plastic forms an electrically insulating layer between the molded parts.

Preferably the molded parts connected to one another consist of different metals or metal alloys.

Particularly preferably the metallic molded parts consist of steel, nickel, chromium, copper, zinc, titanium, aluminum or magnesium or of possible alloys of the above-mentioned metals.

The thermoplastic molding composition may be a non-reinforced or reinforced or filled resin, e.g., based on polyamide (PA), polyester, in particular polyethylene terephthalate (PET), polybutylene terephthalate (PBT), polyolefin, in particular polypropylene (PP), polyethylene (PE), styrene-acrylonitrile copolymer, in particular acrylonitrile-styrene-butadiene copolymer (ABS), polycarbonate (PC), polypropylene oxide (PPO), (PSO). polyphenylene sulphide (PPS), polyimide (PI), (PEEK) or consist of a possible mixture of said resins.

There has proved to be particularly advantageous a laminated component in which there are provided in the molded metal parts, at mutually superimposed points, openings or bores through which the thermoplastic molding composition projects and to which the thermoplastic molding composition is anchored.

Additionally or alternatively there may in a further preferred variant of the laminated component be provided, at mutually superimposed points in the molded metal parts, deformations, in particular beads or bosses, to which the thermoplastic molding composition is anchored.

The invention therefore further provides a process for producing a laminated component according to the invention, characterized in that two or more molded metal parts are introduced into an injection mold and in so doing held apart and thereafter the junction point of the molded metal parts in the injection mold is encapsulated wholly or partly by thermoplasticmolding composition, wherein the thermoplastic molding composition fills the gap between the molded metal parts.

Preferred is a process in which open metal profiles are used and reinforcing struts are produced in the open profiles during the gating of the thermoplastic molding composition.

In order to improve the rigidity of open profiles, in a particularly preferred process additional reinforcing struts are produced in the area of the junction point during the gating of the thermoplastic molding composition.

Since the jointing process is achieved by means of a thermal forming of the thermoplastic component, the shrinkage of the thermoplastic molding composition may be exploited for the build-up of stresses which provide for a permanent and strong laminate in the area of the connection point of the molded metal parts.

There may therefore over and above this be integrated into the laminated component further additional elements which fulfil mechanical functions such as, e.g., the supporting of additional plates or supports, the securing of parts to be attached subsequently or the seating of further components. Said integrated elements may be produced on the one hand with the aid of further elements of high strength materials introduced with form closure and on the other by the integral molding of beads, cutouts or screw domes by means of a thermoplastic component.

The advantages achieved with the invention may be summarized as follows:

The invention makes possible the assembly of permanently high strength and high rigidity knots and laminated components with the use of simply formed semifinished products consisting of metals not connectable to one another, e.g. by welding. In this way electrochemical corrosion at the contact points is prevented, in particular with use in humid environment (vehicle construction).

The simultaneous jointing of several joint areas within an injection mold is possible:

The forming of laminated components may be optimized with respect to cost and weight.

The invention further provides for the use of the laminated components according to the invention in corresponding form as construction elements for machines, vehicles and components of all kinds, in particular for motor vehicles, for electronic articles, household articles and for building materials.

Particularly suitable applications of the laminated component are structural parts for motor vehicles, in particular doors, bumpers, brackets, front and rear parts for passenger cars, sill support frames and trim elements which combine an increased strength with other material properties.

The invention will be explained in greater detail below with reference to figures, without the invention thereby being limited in any particular.

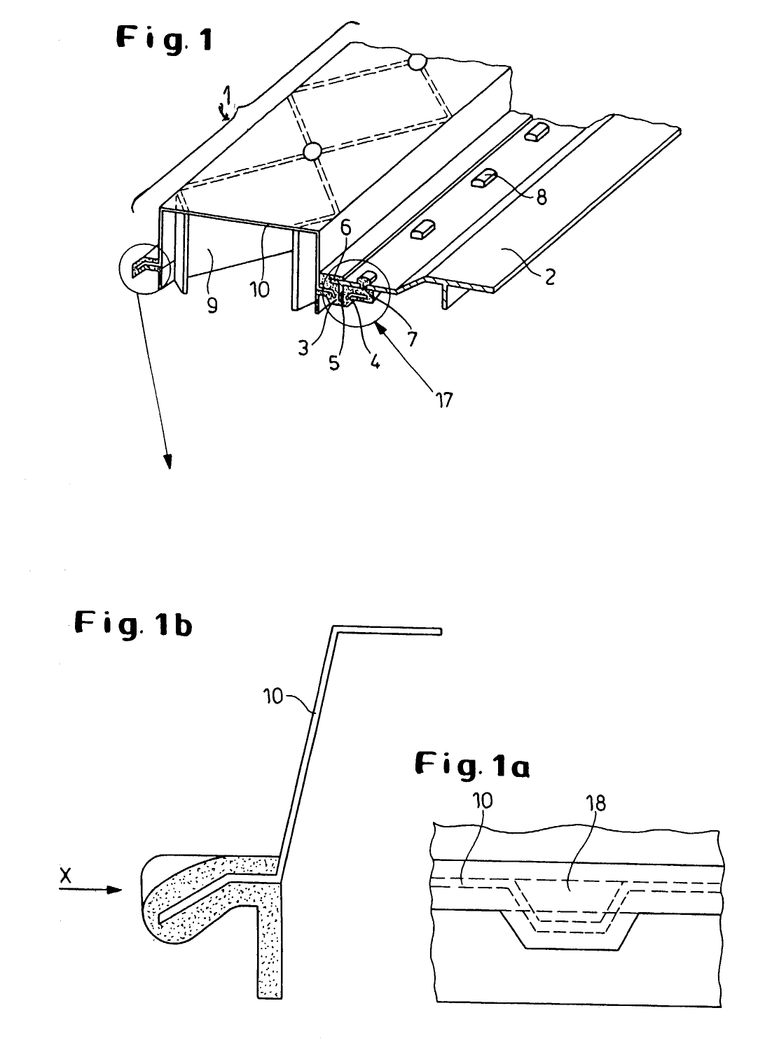

FIG. 1 shows a laminated component with two reinforcement elements 9 for connecting two rectangular profiles connected by a injected thermoplastic molding composition, and the area of the connection point, 17,

FIG. 1a, 1b show magnified partial views of the structure 1 according to

FIG. 1 in cross-section,

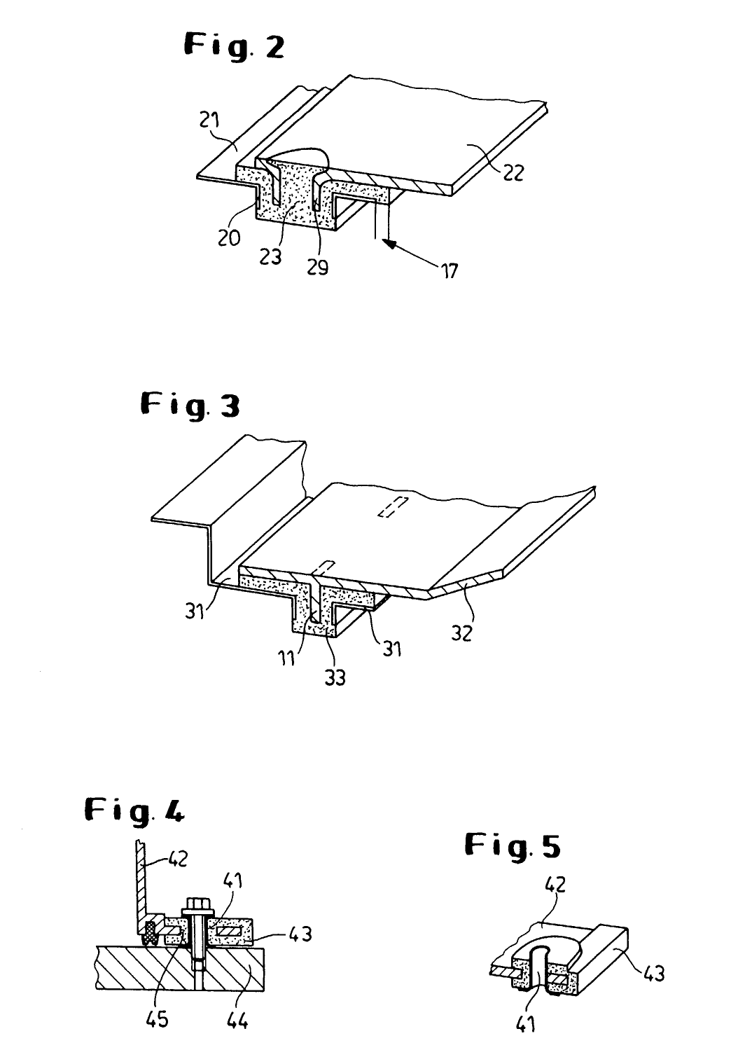

FIG. 2 shows a laminated component similar to FIG. 1 with an additional reinforcing edge,

FIG. 3 a laminated component similar to FIG. 1 with a connection by shrunk-on thermoplastic molded parts 4, 5,

FIG. 4 a laminated component similar to FIG. 1 but without lateral ribbed structures on the thermoplastic and with one-part reinforcement element 3, and

FIG. 5 the laminated component according to FIG. 4.

### EXAMPLES

FIG. 1 shows a plastic-metal hybrid structure 1 (consisting of a ribbed thermoplastic plastic part 9 and a steel plate 10), which is connected to an aluminum or magnesium die-cast cover 2 (frame 2) or else alternatively to a cover (frame) produced by deep drawing and punching. The connection of the various metal parts takes place in such a way that the metals (here steel and aluminum or magnesium) do not make direct contact, in order to prevent electrolytic corrosion. In FIG. 1, the connection takes place via the injected thermoplastic molding composition 3 by, in the plate 10, a punched hole with flanged edge 4 receiving without contact an integrally cast pin 5 of part 2 and the plastic embracing the edge 6 of part 2. Since the plastic also embraces the flanged edge 4, both parts are connected with form closure. Further openings 7 in the part 2 permit a cramping between part 1 and part 2 via the plastic by means of corresponding rivet head connections 8 during the injection molding.

FIG. 1a shows the connection between plastic part 9 and a steel plate 10 in the flange area in such a way that a bead 18 produces the force- and form-closed connection between plastic part and steel plate.

FIG. 1b shows a section through the bead 18 of FIG. 1a.

A further possibility is to be seen in FIG. 2, in which the part 22 exhibits an integrally molded hollow shaft 29 which is introduced contact-free into the flanged opening 20 of the part 21. Here also part 21 and part 22 are connected via the plastic 23.

In FIG. 3 the connection between part 31 and part 32 likewise takes place via the plastic 33, however part 32 comprises no openings and also no edge encapsulation in the connection area. Part 32 comprises pins or bars 11, which exhibit a chemical surface treatment or are provided with an adhesion agent or exhibit a surface structure, so that an adhesion between plastic and metal is obtained, which in addition to the shrinkage forces makes an additional anchoring to the metal possible.

Tensile shear tests on treated test specimens consisting of an aluminum-plastic laminate of the kind shown above show high strength values, particularly in conjunction with PA-GF (polyamide glass fibre reinforced). Said values may also be achieved with magnesium or aluminum-Mg alloys.

In FIG. 4 the securing of the magnesium/aluminum housing 42 is illustrated in a cutaway view. A corrosion-proofed steel bush 41 is here embedded into the Mg/Al housing 42 via the plastic 43 (force and form closure). Contact between metal bush 41 and housing 42 is thereby prevented and the housing 42 may be secured conventionally with a steel screw on the mounting plate 44.

The metal bush 41 with small collar and the large bore 45 in the Mg housing 42 may be embedded directly during the injection molding, because the metal bush 41 may be adjusted through the bore 45 of the Mg housing 42 in an injection mould, so that a constant cavity is created for the seating of the plastic component 43. The plastic component 43 connects the metal bush 41 to the Mg housing 42 with form closure.

It is also possible, however, to gate only the plastic bushes 43 to the Mg housing 42 and to roll the metal bushes 41 into the plastic bush later. The metal bush 41 makes a metric bolting without excessive losses in the tightening torque possible, so that screw locking is ensured.

Although the invention has been described in detail in the foregoing for the purpose of illustration, it is to be understood that such detail is solely for that purpose and that variations can be made therein by those skilled in the art without departing from the spirit and scope of the invention except as it may be limited by the claims.

What is claimed is:

1. A laminated plastic and metal component containing at least two metallic molded parts connected to one another by injected thermoplastic molding composition where in their connection the molded parts form with the thermoplastic resin a form closure, said molded parts having no direct contact one with the other, and said thermoplastic resin forming an electrically insulating layer between said molded parts.

2. The laminated component of claim 1, wherein molded parts consist of metals or metal alloys and are different one from the other.

3. The laminated component of claim 1 wherein the metallic molded parts independently one of the other contain a metal or an alloy thereof, said metal selected from the group consisting of steel, nickel, chromium, copper, zinc, titanium, aluminum and magnesium.

4. The laminated component of claim 1 wherein said metal molded parts include, at mutually superimposed points, openings or bores through which said injected thermoplastic molding composition projects and to which the injected thermoplastic molding composition is anchored.

5. The laminated component of claim 1 wherein said metal molded parts comprise, at mutually superimposed points, deformations to which the injected thermoplastic molding composition is anchored.

6. The laminated component of claim 1 wherein said metal molded parts form open profiles in which additional reinforcement struts are formed by the injected thermoplastic molding composition.

7. The laminated component of claim 1 wherein the injected thermoplastic molding composition is a non-reinforced or reinforced or filled plastic.

8. The laminated component of claim 7 wherein the plastic is at least one a member selected from the group consisting of polyamide, polyester, polyolefin, styrene-acrylonitrile copolymer, polycarbonate, polypropylene oxide, PSO, polyphenylene sulphide, polyimide and PEEK.

9. A process for producing the laminated component of claim 1 comprising introducing two or more molded metal parts into an injection mold while and encapsulating, at least partly, the junction point of the molded metal parts in the injection mold by thermoplastic molding composition, wherein the injected thermoplastic molding composition fills the gap between said molded metal parts.

10. The process of claim 9 wherein said molded metal parts are open metal profiles and where additional reinforcement struts of the thermoplastic molding composition are produced in the open profiles, during the gating of the thermoplastic molding composition.

11. A method of using the laminated component of claim 1 comprising making a construction element for a machine.

12. A method of using the laminated component of claim 1 comprising making a structural part for a motor vehicle.

13. A laminated plastic and metal component containing at least two metallic molded parts connected to one another by injected thermoplastic molding composition where in their connection the molded parts form with the thermoplastic molding composition a form closure, said molded parts having no direct contact one with the other, and said thermoplastic molding composition forming an electrically insulating layer between said molded parts, said molded parts consist of metals or metal alloys that are different one from the other, and including at mutually superimposed points, openings or bores through which said thermoplastic molding composition projects and to which the thermoplastic molding composition is anchored.
